(19) United States
(12) Patent Application Publication
(10) Pub. No.: US 2019/0368246 A1
(43) Pub. Date: Dec. 5, 2019

(54) FURNITURE HINGE

(71) Applicants: KING SLIDE WORKS CO., LTD., Kaohsiung City (TW); KING SLIDE TECHNOLOGY CO., LTD., Kaohsiung City (TW)

(72) Inventors: KEN-CHING CHEN, KAOHSIUNG CITY (TW); SHIH-LUNG HUANG, KAOHSIUNG CITY (TW); CHENG-I HSU, KAOHSIUNG CITY (TW); CHUN-CHIANG WANG, KAOHSIUNG CITY (TW)

(21) Appl. No.: 16/143,943

(22) Filed: Sep. 27, 2018

(30) Foreign Application Priority Data
May 30, 2018 (TW) 107118837

(51) Int. Cl. E05D 3/14; E05D 11/10

(52) U.S. Cl. CPC E05D 3/142; E05Y 2900/20; E05D 11/1021

(57) ABSTRACT

A furniture hinge includes an arm member, a casing, an inner link, an outer link, and a resilient device. The casing can be opened and closed with respect to the arm member. The inner link is pivotally connected to the arm member via a first shaft and is pivotally connected to the casing via a second shaft. The outer link is pivotally connected to the arm member via a third shaft and is pivotally connected to the casing via a fourth shaft. The resilient device provides a resilient force acting between the casing and the arm member and is not in contact with the periphery of any of the first shaft, the second shaft, the third shaft, and the fourth shaft.

### FIELD OF THE INVENTION

The present invention relates to a furniture hinge.

### BACKGROUND OF THE INVENTION

Generally speaking, furniture hinges with four hinge links make it easier to open and close a movable component (e.g., a door) of a piece of furniture (e.g., a cabinet) with respect to a stationary component (e.g., the frame of the cabinet). U.S. Pat. No. 6,401,298 B1, for example, discloses a furniture hinge that includes a hinge casing and a hinge arm. The hinge casing and the hinge arm are adapted to be mounted on different furniture parts respectively and are connected to each other by means of a plurality of hinge links, e.g., four links (or axles) (9, 10, 11, 12). A pressure spring (e.g., a leg spring) acts on one of the hinge links and has a portion encircling a hinge axle of the hinge link in order to mount the pressure spring to the hinge axle. The disclosure of this patent is incorporated herein by reference.

While FIG. 3 of the '298 B1 patent shows a U-shaped leg spring (13) mounted on and encircling (or wrapped around) a hinge axle (or third axle) (11), the U-shaped spring leg can only lie against a hinge arm (1), rather than be secured at a predetermined position, when not yet mounted to the third axle.

FR 2482998 A2 discloses a hinge that includes four axles (a, b, c, d). According to FIG. 1 and FIG. 2 accompanying the specification of this French patent, a spring (40) encircles (or is wrapped around) an axle (d) in order to provide a resilient force for opening or closing a movable element (2) with respect to a stationary element (10).

JP S60148472 U discloses a hinge that, as shown in the drawings of the specification of this Japanese patent, includes a leaf spring (52) encircling (or wrapped around) an axle (51) in order to provide a resilient force for opening or closing the hinge.

U.S. Pat. No. 5,022,117 A discloses a furniture hinge with a closing mechanism, in which a leaf spring (34) encircles a pin (37) and is partially secured in place by another pin (32).

All the four patents cited above involve encircling or wrapping a spring around a link of a four-link (or axle or pin) assembly in order to mount the spring on the link. Different market demands may arise, however, in consideration of material cost or the wear or damage of hinges that may result from the aforesaid spring mounting method, or more specifically from the contact between a spring and the corresponding link of a four-link (or axle or pin) assembly, after repeated opening and closing.

The prior art, therefore, still leaves room for improvement, and the present invention was developed in the light of the foregoing.

### SUMMARY OF THE INVENTION

The present invention relates to a furniture hinge that has four shafts and whose elastic mechanism can provide a resilient force for opening or closing the furniture hinge.

According to one aspect of the present invention, a furniture hinge includes an arm member, a casing, an inner link, an outer link, and a resilient device. The casing can be opened and closed with respect to the arm member. The inner link has a first end portion and a second end portion. The first end portion of the inner link is pivotally connected to the arm member through a first shaft, and the second end portion of the inner link is pivotally connected to the casing through a second shaft. The outer link also has a first end portion and a second end portion. The first end portion of the outer link is pivotally connected to the arm member through a third shaft, and the second end portion of the outer link is pivotally connected to the casing through a fourth shaft. The resilient device provides a resilient force that acts between the casing and the arm member. The resilient device is not in contact with the periphery of any of the first shaft, the second shaft, the third shaft, and the fourth shaft.

Preferably, the resilient device does not press against and is not pressed by any of the first shaft, the second shaft, the third shaft, and the fourth shaft while the casing is being moved from an opened position to a closed position with respect to the arm member.

Preferably, the resilient device is away from the periphery of each of the first shaft, the second shaft, the third shaft, and the fourth shaft.

Preferably, the arm member includes at least one wall, the at least one wall includes a first mounting structure, and the resilient device includes a second mounting structure to be mounted to the first mounting structure.

Preferably, one of the first mounting structure and the second mounting structure includes a projection, and the other of the first mounting structure and the second mounting structure includes a recess matching the projection.

Preferably, the resilient device includes a resilient member. The resilient member includes a first resilient portion, a second resilient portion, and a bent portion connected between the first resilient portion and the second resilient portion. The first resilient portion of the resilient member is provided with the second mounting structure.

Preferably, the resilient device further includes an inner resilient member. The inner resilient member includes a first resilient portion, a second resilient portion, and a bent portion connected between the first resilient portion and the second resilient portion. The inner resilient is accommodated in a space defined by the first resilient portion, the second resilient portion, and the bent portion of the resilient member. The first resilient portion of the inner resilient member is preferably also provided with the second mounting structure.

Preferably, the first resilient portion, the second resilient portion, and the bent portion of the resilient member correspond in position to the first resilient portion, the second resilient portion, and the bent portion of the inner resilient member respectively.

Preferably, an end portion of the first resilient portion of the resilient member is substantially flush with an end portion of the first resilient portion of the inner resilient member, and an end portion of the second resilient portion of the resilient member is substantially flush with an end portion of the second resilient portion of the inner resilient member.

Preferably, the resilient member is integrated with the inner resilient member.

Preferably, the second resilient portion of the resilient member is configured to be pressed by the first end portion of the inner link.

Preferably, the second resilient portion of the inner resilient member is configured to be pressed by the first end portion of the inner link.

Preferably, the furniture hinge further includes a cap coupled to the inner link at a position adjacent to the first end portion of the inner link, and the second resilient portion of the resilient member has a guide surface for contact with the cap.

Preferably, the cap includes plastic.

Preferably, the resilient member and the inner resilient member are resilient U-shaped plates.

Preferably, the arm member includes a first wall, a second wall, and a third wall connected between the first wall and the second wall. The first mounting structure is located at the third wall.

### BRIEF DESCRIPTION OF THE DRAWINGS

FIG. 1 is a perspective view in which the furniture hinge according to a first embodiment of the present invention is applied to a furniture part assembly;

FIG. 2 is a perspective view of the furniture hinge in according to the first embodiment of the present invention;

FIG. 3 is an exploded perspective view of the furniture hinge according to the first embodiment of the present invention;

FIG. 4 is an enlarged view of the area A in FIG. 3;

FIG. 5 is an enlarged view of the area B in FIG. 3;

FIG. 6 is a schematic view showing that the furniture hinge according to the first embodiment of the present invention is applied to the first furniture part and the second furniture part of the furniture part assembly, with the casing of the furniture hinge at an opened position with respect to the arm member;

FIG. 7 is an enlarged view of the area A in FIG. 6;

FIG. 8 is a schematic view of the furniture hinge according to the first embodiment of the present invention, showing that the casing of the furniture hinge is at a closed position with respect to the arm member;

FIG. 9 is an enlarged view of the area A in FIG. 8;

FIG. 10 is a schematic view showing that the furniture hinge according to a second embodiment of the present invention is applied to a furniture part assembly; and

FIG. 11 is a schematic view showing that the furniture hinge in a third embodiment of the present invention is applied to a furniture part assembly.

### DETAILED DESCRIPTION OF THE INVENTION

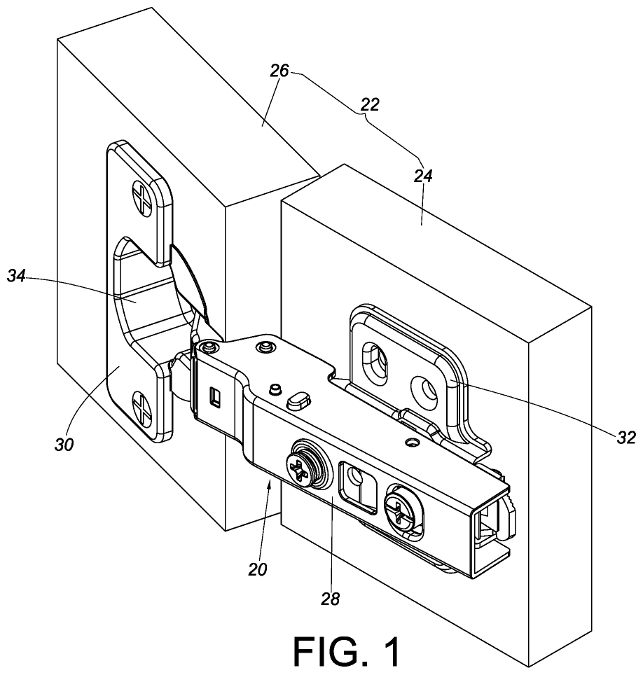

Referring to FIG. 1, the furniture hinge 20 in an embodiment of the present invention is applied to a furniture part assembly 22. The furniture part assembly 22 includes a first furniture part 24 (e.g., the frame of a cabinet) and a second furniture part 26 (e.g., a door of the cabinet). The second furniture part 26 can be opened and closed with respect to the first furniture part 24.

The furniture hinge 20 includes an arm member 28 and a casing 30. The arm member 28 is a hinge arm and is configured to be mounted to the first furniture part 24. For example, the arm member 28 can be threadedly connected to the first furniture part 24. In this embodiment, the arm member 28 is mounted to the first furniture part 24 via a fitting 32. The casing 30, on the other hand, is a hinge cup and has a receiving room 34. The casing 30 is configured to be mounted to the second furniture part 26. For instance, the casing 30 can be threadedly connected to the second furniture part 26.

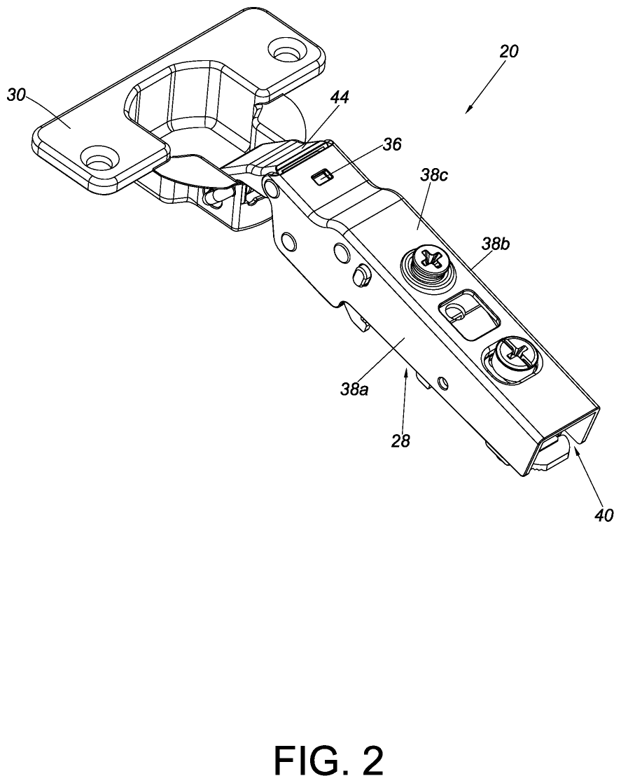

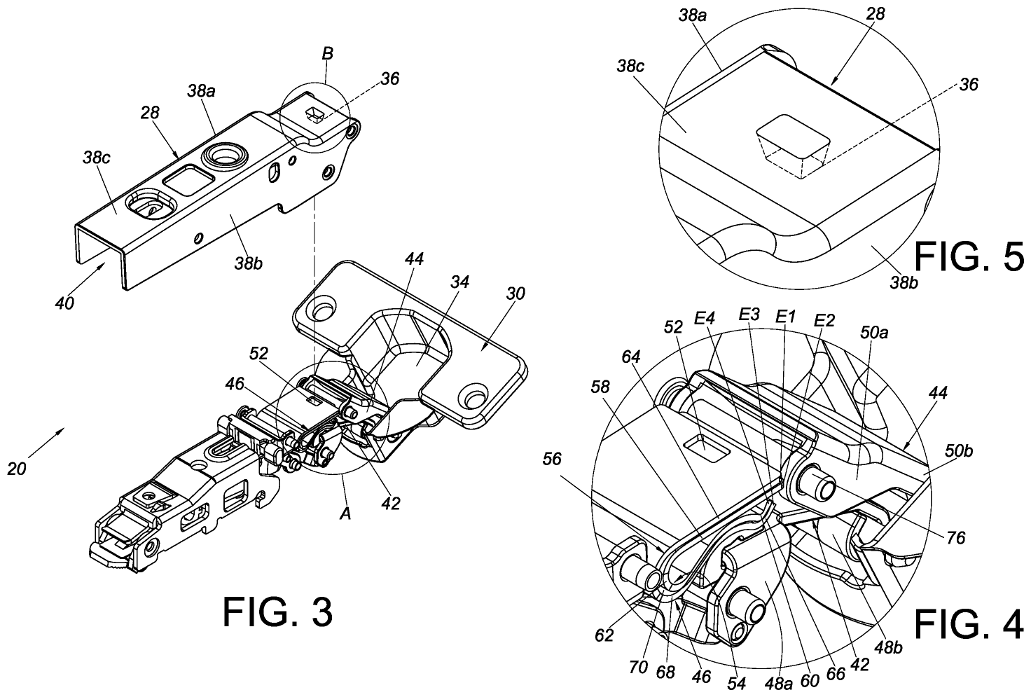

As shown in FIG. 2 and FIG. 3 the arm member 28 of the furniture hinge 20 includes at least one wall, and the at least one wall includes a first mounting structure 36. Here, the arm member 28 includes a first wall 38a, a second wall 38b, and a third wall 38c (or middle wall 38c) connected between the first wall 38a and the second wall 38b; and the first mounting structure 36 is located at the third wall 38c by way of example. More specifically, the first wall 38a and the second wall 38b are substantially perpendicularly connected to the third wall 38c; and the first wall 38a, the second wall 38b, and the third wall 38c jointly define an accommodating space 40 for accommodating related components of the furniture hinge 20.

As shown in FIG. 3 and FIG. 4, the furniture hinge 20 further includes an inner link 42, an outer link 44, and a resilient device 46.

The inner link 42 has a first end portion 48a and a second end portion 48b opposite the first end portion 48a. The outer link 44 has a first end portion 50a and a second end portion 50b opposite the first end portion 50a. The resilient device 46 includes a second mounting structure 52 configured to be mounted to the first mounting structure 36 of the arm member 28 (see also FIG. 5 and FIG. 7). The first mounting structure 36 and the second mounting structure 52 may be a projection and a matching recess. In this embodiment, the first mounting structure 36 is a projecting portion while the second mounting structure 52 is a groove or hole in which the projecting portion can be mounted. In practice, however, the second mounting structure 52 may alternatively be a projecting portion while the first mounting structure 36 is a matching groove or hole; the present invention has no limitation in this respect. The foregoing arrangement is intended to keep the resilient device 46 securely at a predetermined position on the arm member 28 in the initial stage of assembly.

Preferably, the resilient device 46 includes a first resilient member 54 and a second resilient member 56 (the latter also referred to herein as the resilient member; the former also referred to herein as the inner resilient member). The first resilient member 54 and the second resilient members 56 are preferably resilient U-shaped plates. Preferably, the first resilient member 54 and the second resilient members 56 are integrated with each other so as to support and abut against each other. More specifically, the first resilient member 54 includes a first resilient portion 58, a second resilient portion 60, and a bent portion 62 connected between the first resilient portion 58 and the second resilient portion 60 Similarly, the second resilient member 56 includes a first resilient portion 64, a second resilient portion 66, and a bent portion 68 connected between the first resilient portion 64 and the second resilient portion 66. The first resilient portion 64, the second resilient portion 66, and the bent portion 68 of the second resilient member 56 define a space 70 for accommodating the first resilient member 54. The first resilient portion 64, the second resilient portion 66, and the bent portion 68 of the second resilient member 56 correspond in position to the first resilient portion 58, the second resilient portion 60, and the bent portion 62 of the first resilient member 54 respectively. An end portion E1 of the first resilient portion 64 of the second resilient member 56 is substantially flush with an end portion E2 of the first resilient portion 58 of the first resilient member 54 to achieve a level-end configuration. Likewise, an end portion E3 of the second resilient portion 66 of the second resilient member 56 is substantially flush with an end portion E4 of the second resilient portion 60 of the first resilient member 54 to achieve a level-end configuration. The first resilient portion 64 and the second resilient portion 66 of the second resilient member 56 are so configured that the first resilient portion 58 and the second resilient portion 60 of the first resilient member 54 abut against the first resilient portion 64 and the second resilient portion 66 of the second resilient member 56 respectively, thus turning the first resilient member 54 and the second resilient member 56 into a double-layer resilient structure. The second mounting structure 52 in this embodiment is provided at the first resilient portion 58 of the first resilient member 54 as well as at the first resilient portion 64 of the second resilient member 56 by way of example. Therefore, once the second mounting structure 52 is mounted to the first mounting structure 36, both the first resilient portion 58 of the first resilient member 54 and the second resilient portion 64 of the second resilient member 56 press against the third wall 38c of the arm member 28. It is worth mentioning that only the second resilient portion 64 of the second resilient member 56 is provided with the second mounting structure 52 in another embodiment.

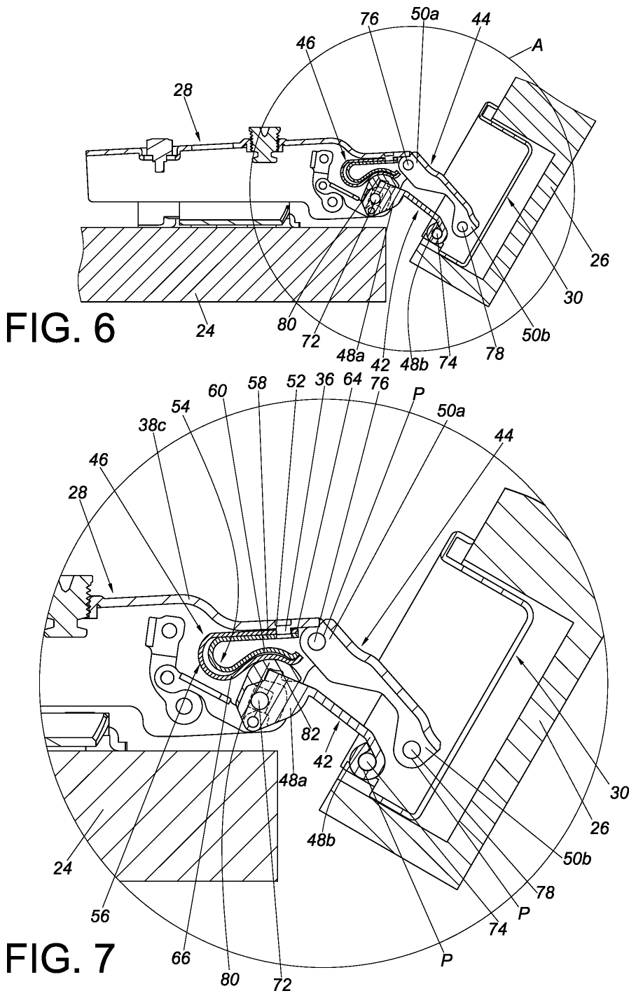

As shown in FIG. 6 and FIG. 7, the casing 30 (or the second furniture part 26) can be opened with respect to the arm member 28 (or the first furniture part 24). The resilient device 46 provides a resilient force acting between the casing 30 and the arm member 28. The second mounting structure 52 of the resilient device 46 is mounted to or positioned at the first mounting structure 36 of the arm member 28.

More specifically, the first end portion 48a of the inner link 42 is pivotally connected to the arm member 28 through a first shaft 72, and the second end portion 48b of the inner link 42 is pivotally connected to the casing 30 through a second shaft 74 Similarly, the first end portion 50a of the outer link 44 is pivotally connected to the arm member 28 through a third shaft 76, and the second end portion 50b of the outer link 44 is pivotally connected to the casing 30 through a fourth shaft 78. Preferably, the second resilient portion 60 of the first resilient member 54 and/or the second resilient portion 66 of the second resilient member 56 is configured to be pressed by the first end portion 48a of the inner link 42. Preferably, the furniture hinge 20 further includes a cap 80 coupled to the inner link 42 at a position adjacent to the first end portion 48a, and the second resilient portion 60 of the first resilient member 54 and/or the second resilient portion 66 of the second resilient member 56 has a corresponding guide surface 82, such as a curved surface. The guide surface 82 is configured to be in contact with the cap 80 when the casing 30 (or the second furniture part 26) is opened with respect to the arm member 28 (or the first furniture part 24). Preferably, the cap 80 includes plastic and has a portion encircling the periphery of the first shaft 72.

In addition, the inner side of the third wall 38c of the arm member 28 is pressed by the first resilient portion 58 of the first resilient member 54 and the first resilient portion 64 of the second resilient member 56, and the cap 80 is pressed by the second resilient portion 60 of the first resilient member 54 and the second resilient portion 66 of the second resilient member 56. Thus, the first resilient portion 58 of the first resilient member 54 and the first resilient portion 64 of the second resilient member 56 act on the arm member 28 directly, and the second resilient portion 60 of the first resilient member 54 and the second resilient portion 66 of the second resilient member 56 act on the casing 30 indirectly (i.e., through the cap 80), in order for the resilient device 46 to provide a resilient force acting between the casing 30 and the arm member 28.

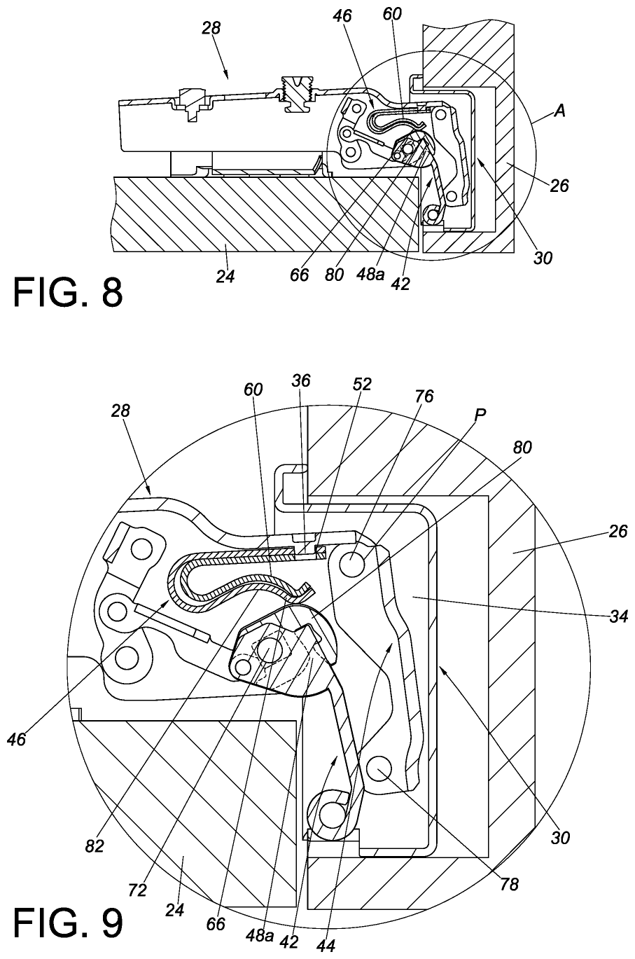

As shown in FIG. 6 and FIG. 8, the casing 30 (or the second furniture part 26) can be moved from an opened position to a closed position with respect to the arm member 28 (or the first furniture part 24) by a user's operation. In the course in which the casing 30 (or the second furniture part 26) is moved from the opened position to the closed position with respect to the arm member 28 (or the first furniture part 24), the resilient device 46 provides a resilient force acting between the casing 30 and the arm member 28, thereby imparting a force (e.g., a closing force) to the casing 30 that tends to move the casing 30 from the opened position to the closed position with respect to the arm member 28.

Referring to FIG. 8 and FIG. 9, when the casing 30 (or the second furniture part 26) is closed with respect to the arm member 28 (or the first furniture part 24), the cap 80 is away from the guide surface 82, and the first end portion 48a of the inner link 42 presses the second resilient portion 60 of the first resilient member 54 and the second resilient portion 66 of the second resilient member 56 through the cap 80. Moreover, the inner link 42 and the outer link 42 are accommodated in the receiving room 34 of the casing 30.

It is worth mentioning that the resilient device 46 is not in contact with the periphery P of any of the first shaft 72, the second shaft 74, the third shaft 76, and the fourth shaft 78 (or is away from the periphery P of each shaft), and that therefore the resilient device 46 (e.g., the first resilient member 54 or the second resilient member 56) need not be as long as or use as much material as its counterparts in the prior art. Besides, as shown in FIG. 6 to FIG. 9, the first mounting structure 36 and the second mounting structure 52 are so mounted that, in the course in which the casing 30 (or the second furniture part 26) is moved from the opened position to the closed position with respect to the arm member 28 (or the first furniture part 24), the resilient device 46 does not press against and is not pressed by any of the first shaft 72, the second shaft 74, the third shaft 76, and the fourth shaft 78; in other words, the resilient device 46 is not supported by the first shaft 72, the second shaft 74, the third shaft 76, or the fourth shaft 78.

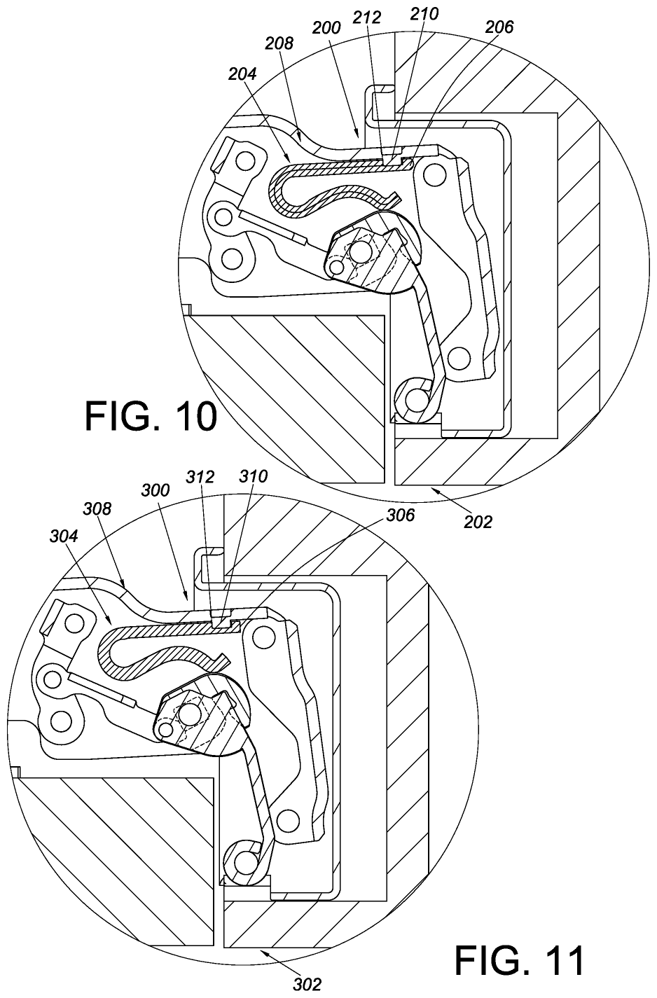

FIG. 10 shows the furniture hinge 200 in the second embodiment of the present invention applied to a furniture part assembly 202. Unlike the resilient device 46 in the first embodiment, which is a double-layer resilient structure consisting of the first resilient member 54 and the second resilient member 56, the resilient device 204 of the furniture hinge 200 in the second embodiment includes a resilient member 206, which is made of a one-piece material processed in advance by being folded and shaped into a double-layer resilient structure. In other words, the resilient member 206 in the second embodiment can be roughly deemed as an integration of the second resilient member 56 and the first resilient member 54 in the first embodiment. The second mounting structure 212 of the resilient member 206 of the resilient device 204 is configured to be mounted to the first mounting structure 210 of the arm member 208 of the resilient device 204.

FIG. 11 shows the furniture hinge 300 in the third embodiment of the present invention applied to a furniture part assembly 302. Unlike the resilient device 46 in the first embodiment, which is a double-layer resilient structure consisting of the first resilient member 54 and the second resilient member 56, the resilient device 304 of the furniture hinge 300 in the third embodiment includes a resilient member 306, which is a single-layer resilient structure. In other words, the resilient member 306 in the third embodiment can be roughly deemed as the second resilient member 56 in the first embodiment being solely used. The second mounting structure 312 of the resilient member 306 of the resilient device 304 is configured to be mounted to the first mounting structure 310 of the arm member 308 of the resilient device 304.

It can be known from the above that the furniture hinges disclosed herein preferably have the following features:
1. The resilient device 46 is not in contact with the periphery P of any of the first shaft 72, the second shaft 74, the third shaft 76, and the fourth shaft 78 (or is away from the periphery P of each shaft) and can therefore have a shorter length and use less material than its counterparts in the prior art.
2. The first mounting structure 36 and the second mounting structure 52 are so mounted that, in the course in which the casing 30 is moved from the opened position to the closed position with respect to the arm member 28, the resilient device 46 does not press against and is not pressed by any of the first shaft 72, the second shaft 74, the third shaft 76, and the fourth shaft 78.
3. The end portion E1 of the first resilient portion 64 of the second resilient member 56 is substantially flush with the end portion E2 of the first resilient portion 58 of the first resilient member 54 to achieve a level-end configuration. Similarly, the end portion E3 of the second resilient portion 66 of the second resilient member 56 is substantially flush with the end portion E4 of the second resilient portion 60 of the first resilient member 54 to achieve a level-end configuration.
4. The resilient device of any of the furniture hinges disclosed herein can be fixed at a predetermined position in the initial stage of assembly to ensure the stability of the resilient arrangement of the furniture hinge.

While the present invention has been disclosed by way of the foregoing preferred embodiments, it should be understood that the embodiments provided herein are not intended to be restrictive of the invention. The scope of patent protection sought by the applicant is defined by the appended claims.

What is claimed is:

1. A furniture hinge, comprising:
an arm member;
a casing configured to be opened and closed with respect to the arm member;
an inner link having a first end portion and a second end portion, wherein the first end portion of the inner link is pivotally connected to the arm member via a first shaft, and the second end portion of the inner link is pivotally connected to the casing via a second shaft;
an outer link having a first end portion and a second end portion, wherein the first end portion of the outer link is pivotally connected to the arm member via a third shaft, and the second end portion of the outer link is pivotally connected to the casing via a fourth shaft; and
a resilient device for providing a resilient force acting between the casing and the arm member;
wherein the resilient device is not in contact with a periphery of any of the first shaft, the second shaft, the third shaft, and the fourth shaft.

2. The furniture hinge of claim 1, wherein the arm member includes at least one wall, the at least one wall includes a first mounting structure, and the resilient device includes a second mounting structure configured to be mounted to the first mounting structure.

3. The furniture hinge of claim 2, wherein one of the first mounting structure and the second mounting structure includes a projection, and the other of the first mounting structure and the second mounting structure includes a recess matching the projection.

4. The furniture hinge of claim 2, wherein the resilient device includes a resilient member; the resilient member includes a first resilient portion, a second resilient portion, and a bent portion connected between the first resilient portion and the second resilient portion of the resilient member; and the first resilient portion of the resilient member is provided with the second mounting structure.

5. The furniture hinge of claim 4, wherein the resilient device includes an inner resilient member; the inner resilient member includes a first resilient portion, a second resilient portion, and a bent portion connected between the first resilient portion and the second resilient portion of the inner resilient member; the inner resilient member is accommodated in a space defined by the first resilient portion, the second resilient portion, and the bent portion of the resilient member.

6. The furniture hinge of claim 5, wherein the first resilient portion, the second resilient portion, and the bent portion of the resilient member correspond in position to the first resilient portion, the second resilient portion, and the bent portion of the inner resilient member respectively.

7. The furniture hinge of claim 5, wherein an end portion of the first resilient portion of the resilient member is substantially flush with an end portion of the first resilient portion of the inner resilient member, and an end portion of the second resilient portion of the resilient member is substantially flush with an end portion of the second resilient portion of the inner resilient member.

8. The furniture hinge of claim 5, wherein the resilient member is integrated with the inner resilient member.

9. The furniture hinge of claim 4, wherein the second resilient portion of the resilient member is configured to be pressed by the first end portion of the inner link.

10. The furniture hinge of claim 5, wherein the second resilient portion of the inner resilient member is configured to be pressed by the first end portion of the inner link.

11. The furniture hinge of claim 9, further comprising a cap coupled to the inner link at a position adjacent to the first end portion of the inner link, and the second resilient portion of the resilient member has a guide surface for contact with the cap.

12. The furniture hinge of claim 11, wherein the cap includes plastic.

13. The furniture hinge of claim 5, wherein the resilient member and the inner resilient member are resilient U-shaped plates.

14. The furniture hinge of claim 2, wherein the arm member includes a first wall, a second wall, and a third wall connected between the first wall and the second wall; and the first mounting structure is located at the third wall.

15. A furniture hinge, comprising:
an arm member;
a casing configured to be opened and closed with respect to the arm member;
an inner link having a first end portion and a second end portion, wherein the first end portion of the inner link is pivotally connected to the arm member via a first shaft, and the second end portion of the inner link is pivotally connected to the casing via a second shaft;
an outer link having a first end portion and a second end portion, wherein the first end portion of the outer link is pivotally connected to the arm member via a third shaft, and the second end portion of the outer link is pivotally connected to the casing via a fourth shaft; and
a resilient device for providing a resilient force acting between the casing and the arm member;
wherein the resilient device does not press against and is not pressed by any of the first shaft, the second shaft, the third shaft, and the fourth shaft while the casing is being moved from an opened position to a closed position with respect to the arm member.

16. The furniture hinge of claim 15, wherein the arm member includes at least one wall, the at least one wall includes a first mounting structure, and the resilient device includes a second mounting structure configured to be mounted to the first mounting structure.

17. The furniture hinge of claim 16, wherein the resilient device includes a resilient member; the resilient member includes a first resilient portion, a second resilient portion, and a bent portion connected between the first resilient portion and the second resilient portion; and the first resilient portion of the resilient member has the second mounting structure.

18. The furniture hinge of claim 17, wherein the resilient member is a resilient U-shaped plate.

19. A furniture hinge, comprising:
an arm member;
a casing configured to be opened and closed with respect to the arm member;
an inner link having a first end portion and a second end portion, wherein the first end portion of the inner link is pivotally connected to the arm member via a first shaft, and the second end portion of the inner link is pivotally connected to the casing via a second shaft;
an outer link having a first end portion and a second end portion, wherein the first end portion of the outer link is pivotally connected to the arm member via a third shaft, and the second end portion of the outer link is pivotally connected to the casing via a fourth shaft; and
a resilient device for providing a resilient force acting between the casing and the arm member;
wherein the resilient device is away from a periphery of each of the first shaft, the second shaft, the third shaft, and the fourth shaft.

20. The furniture hinge of claim 19, wherein the arm member includes at least one wall, the at least one wall includes a first mounting structure, and the resilient device includes a second mounting structure configured to be mounted to the first mounting structure.
